(19) United States
(12) Patent Application Publication
(10) Pub. No.: US 2004/0015000 A1
(43) Pub. Date: Jan. 22, 2004

(54) Process for stabilizing unsaturated oils

(76) Inventors: Berit Annie Aanesen, Skien (NO); Harald Breivik, Porsgrunn (NO)

Correspondence Address: FITZPATRICK CELLA HARPER & SCINTO, 30 ROCKEFELLER PLAZA, NEW YORK, NY, 10112, US

(21) Appl. No.: 10/333,329

(22) PCT Filed: Jun. 27, 2001
(86) PCT No.: PCT/NO01/00271

(30) Foreign Application Priority Data
Jul. 18, 2000 (NO) 2000 3676

(51) Int. Cl. C11B 1/00

(52) U.S. Cl. 554/8

(57) ABSTRACT

A process for stabilising unsaturated oils is provided which comprises treating a raw material with an organic acid prior to separating the oil from the raw material.

This invention relates to a process for stabilising unsaturated oils which are prone to atmospheric oxidation.

It is well-known that unsaturated oils are vulnerable to oxidation in the atmosphere and such oxidation results in degradation and low quality of the fat components of the oil. Moreover, such oxidation is catalysed by metal ions, such as Fe²⁺, Cu²⁺ and others, which may be present in the raw material as well as in the oil.

When the fat reacts with oxygen in the atmosphere, primary oxidation products, such as peroxides, are formed first. However, these peroxides are unstable and break down easily into secondary oxidation products. These secondary oxidation products consist of a complex group of compounds, such as aldehydes and ketones, which often have a pronounced taste and/or smell and may have deleterious effects on health.

It will be apparent from the above that the presence of primary and secondary oxidation products in an unsaturated oil is a problem for the oil manufacturing industry as well as for consumers of such unsaturated oils. There are therefore international regulations which state maximum oxidation levels for oil products (see, for example, European Pharmacopoeia monograph 1998:1192 and 1193 for cod-liver oil).

Traditionally, antioxidants have been added directly to the processed oil to protect it from further oxidation. However, the processing procedure induces an oxidative stress in the raw material and therefore in the resultant oil which cannot be reversed by the addition of antioxidants to the fresh oil. It would therefore be highly advantageous to be able to produce unsaturated oils with levels of oxidation products which are as low as possible.

The stability of an oil is also very important when considering the possible storage time of the oil. It would therefore also be highly desirable to be able to increase the storage stability of an unsaturated oil with regard to oxidation.

It is already known to add an organic acid, such as citric acid, to a freshly extracted unsaturated oil during the oil processing procedure, for instance, to remove phospholipids. However, surprisingly, it has now been found that the level of oxidation products in the oil can be reduced and the storage stability of the oil can be increased if an organic acid is added to the raw material before it enters the oil manufacturing process.

According to the present invention there is therefore provided a process for stabilising an unsaturated oil which comprises treating the raw material with an organic acid prior to separating the oil from the raw material.

Preferably, the unsaturated oil is a vegetable, marine or single cell oil. It is particularly preferred that the unsaturated oil is a marine oil, such as a fish oil, seal oil or whale oil. Fish oils, such as oils from salmon, herring, anchovy, sardine, pilchard, shark etc. and mixtures thereof, are preferred with salmon oil being especially preferred. Polyunsaturated oils are also preferred and omega-3 and omega-6 unsaturated oils are especially preferred.

The organic acid may be an optionally substituted short chain mono-, di- or tri-basic carboxylic acid, an alkylenediaminetetraacetic acid or a mixture thereof Preferably, such short chain carboxylic acids contain from 1 to 6, more preferably 1 to 4, carbon atoms. Optional substituents for such short chain carboxylic acids include halogen atoms, nitro, cyano and hydroxyl groups. If an alkylenediaminetetraacetic acid is utilised, it is preferred that the alkylene moiety contains from 2 to 4, preferably 2 to 3, and especially 2, carbon atoms. More preferably, the organic acid is an optionally substituted C₁₋₃ monobasic carboxylic acid, such as methanoic, ethanoic or propanoic acid, a dibasic carboxylic acid, such as oxalic, malonic or succinic, especially oxalic, acid, a tribasic carboxylic acid such as citric acid or ethylenediaminetetraacetic acid. However, it is particularly preferred that the organic acid is citric acid.

Preferably, the organic acid is added to the raw material in a minimum amount of 50 mg per kg of oil in the raw material. However, an amount of 50 to 1000 mg, preferably 60 to 500 mg and especially 70 to 200 mg, per kg of oil in the raw material is preferred.

Although addition of an organic acid to the raw material prior to separating the oil from the raw material in accordance with the invention has advantageous effects, these can be enhanced still further by the addition of an antioxidant to the processed oil. Any suitable antioxidant may be used in this respect. However, it is preferred that the antioxidant is selected from the group consisting of tocopherols, ascorbyl palmitate, lecithin, tocotrienols and mixtures thereof One preferred antioxidant mixture comprises a mixture of a tocopherol, especially α-tocopherol, ascorbyl palmitate and lecithin. Another preferred antioxidant mixture comprises a mixture of tocotrienols, ascorbyl palmitate and lecithin. One suitable mixture comprises a mixture of a tocopherol, preferably α-tocopherol, ascorbyl palmitate and lecithin in which the components of this mixture are present in a ratio of 1-3:3-5:4-6, preferably 2:4:5, of tocopherol: ascorbyl palmitate: lecithin. When such a mixture is utilised, the tocopherol, ascorbyl palmitate and lecithin may be added to the processed oil in a combined amount of 500 to 2000 ppm, more preferably 800-1500 ppm and especially 1000-1200 ppm. Suitable amounts of tocopherol are 150-250, especially 180-220, ppm. Suitable amounts of ascorbyl palmitate are 300-500, especially 350-450, ppm. Suitable amounts of lecithin are 300-700, especially 400-600, ppm.

The invention is further illustrated by the following examples. In these examples the oxidation parameters known as peroxide value (POV), p-anisidine value (p-AV) and total oxidation value (Totox) were measured. The POV provides a measurement of the extent of oxidation in oils and, in particular, an indication of the level of primary oxidation products whereas the p-AV provides an indication of the amount of secondary oxidation products, such as high molecular weight saturated and unsaturated carbonyl compounds, in the oil.

POV is measured by standard iodometric procedures which involve measuring, by titration or colorimetric or electrometric methods, the iodine produced by potassium iodide added as a reducing agent in the oxidised sample dissolved in a chloroform-ethanoic acid mixture. The liberated iodine is titrated with standard sodium thiosulphate to a starch endpoint. Alternatively, the iodine starch-end point may be determined colormetrically or the liberated iodine can be measured electrometrically by reduction at a platinium electrode maintained at a constant potential. POV is expressed as milliequivalents of iodine per kg of lipid (meq/kg).

The p-AV value is measured by determining the intensity of a colour which develops during a reaction between p-anisidine and aldehydes in the oil in accordance with known procedures. Specifically, p-AV is defined as the absorbance of a solution resulting from the reaction of 1 g fat in 100 ml of isooctane solvent and reagent (0.25% p-anisidine in glacial ethanoic acid).

The so-called totox value is calculated according to the equation:—

Totox=2POV+p-AV

Totox is used as a measure of the precursor non-volatile carbonyls present in a processed oil plus any further oxidation products developed after storage.

The induction period (IP), which provides an indication of the storage stability of an oil, was also measured in accelerated tests. The test procedure utilises the fact that a sample oil will gain weight as it reacts with oxygen in the air. At a certain point in time, the weight increase will be rapid as the resistance of the oil to oxidation reaches zero. The time to this point is the IP of the oil. Thus, the IP is measured by storing small oil samples exposed to air and recording their weight increase as the oil reacts with oxygen from the air.

### EXAMPLE 1

In production of oil from 572 kg fresh salmon offal (viscera, whole fish—downgraded, filleting by-products: heads, off-cuts, skin, frame bones; oil content: about 25% by weight of raw material) from a filleting factory, 12.5 g citric acid (c.a.) was added to the raw material when entering the process. This corresponds to about 90 mg citric acid per kg oil in the raw material. However, as citric acid has a very low solubility in oil compared to water, the citric acid concentration in the produced oil is believed to be very small.

The raw material was minced and then processed using a scraped surface heat exchanger and a decanter centrifuge to separate it into three fractions: solid (grax), aqueous (stickwater) and lipid (oil). The process was thermally gentle (heating to 90-95° C. for 4-5 minutes). The oil was obtained directly from the decanter centrifuge, without any further separation. To the fresh oil, 200 ppm d-α-tocopherol, 400 ppm ascorbyl palmitate and 500 ppm lecithin were added as antioxidants (ao) to give oil H.

The oxidation parameters POV, p-AV and Totox were measured, and compared with POV, p-AV and Totox from an oil produced in the same manner from similar raw material, but without any additions (oil A). The IP of both oils was measured in 3 g samples at 30° C., and compared. The results are given in Table 1 below.

TABLE 1

| Oil | Treatment | POV (meq/kg) | p-AV | Totox | IP (days) |
|---|---|---|---|---|---|
| Oil H | c.a. in raw mat., ao in | 0.05 | 0.0 | 0.1 | 42 |
| | oil | | | | |
| Oil A | None | 1.45 | 1.5 | 4.4 | 9 |

### EXAMPLE 2

POV, p-AV, Totox and IP from oil H, produced as described in Example 1, were compared with POV, p-AV, Totox and IP from an oil (oil B) produced in the same manner from similar raw material, but with citric acid and antioxidant additions only to the fresh oil, not to the raw material. Oil B contained 200 ppm d-α-tocopherol, 400 ppm ascorbyl palmitate, 500 ppm lecithin and 100 ppm citric acid. The level of citric acid in oil H was not measured, but was believed to be very low as citric acid has a low solubility in oil. The IPs of both oils were measured in 3 g samples at 30° C. The results are given in Table 2 below.

TABLE 2

| Oil | Treatment | POV (meq/kg) | p-AV | Totox | IP (days) |
|---|---|---|---|---|---|
| Oil H | c.a. in raw mat., ao in | 0.05 | 0.0 | 0.1 | 42 |
| | oil | | | | |
| Oil B | c.a. and ao in oil | 0.49 | 2.6 | 3.6 | 29 |

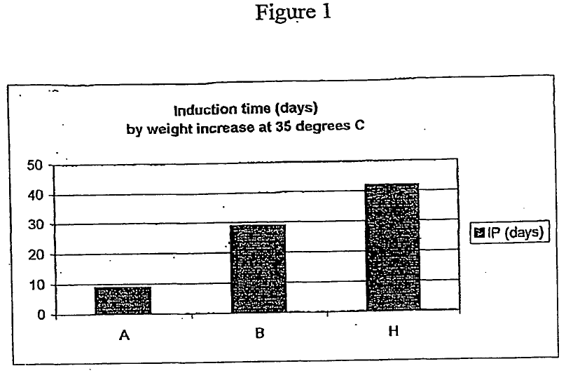

The combined results of Examples 1 and 2 are also shown graphically in FIGS. 1 to 4 in which FIG. 1 is a block graph showing the induction time (IP) of oils A, B and H in days,

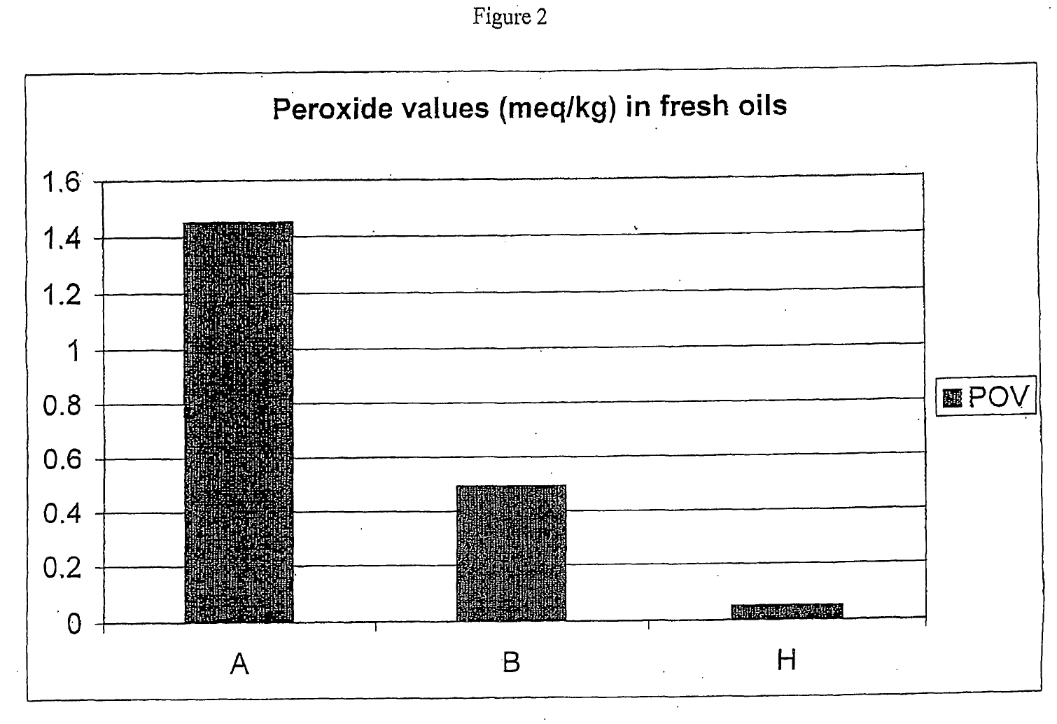

FIG. 2 is a block graph showing the peroxide value.(POV) of oils A, B and H in milliequivalents of iodine per kg of oil (meq/kg),

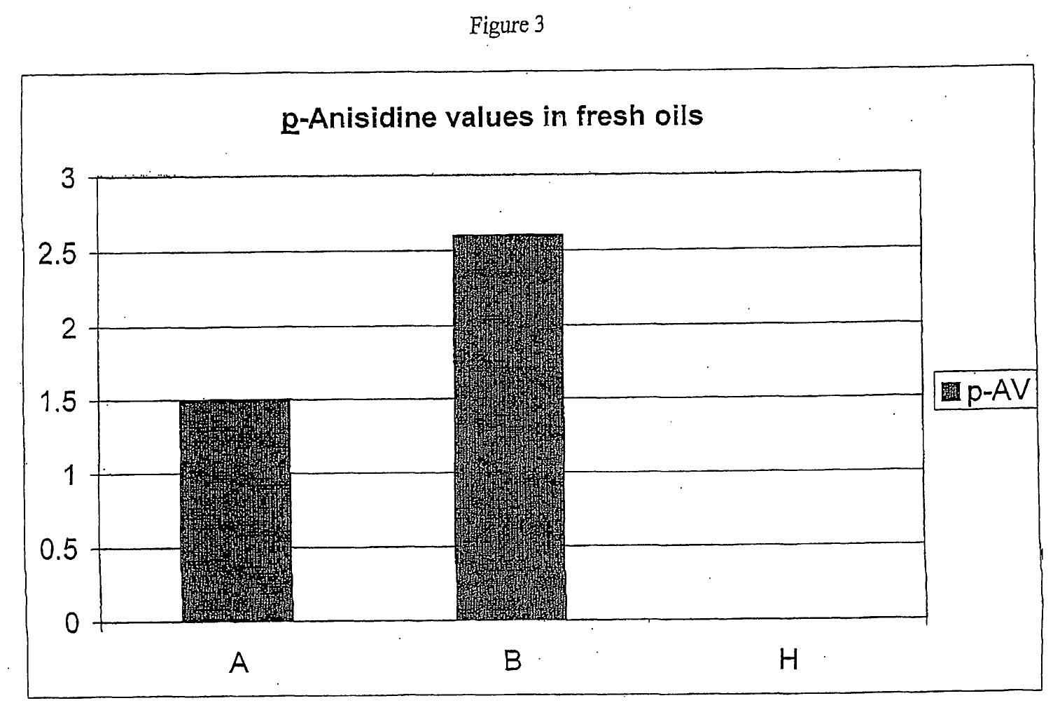

FIG. 3 is a block graph showing the p-anisidine value (p-AV) of oils A, B and H and

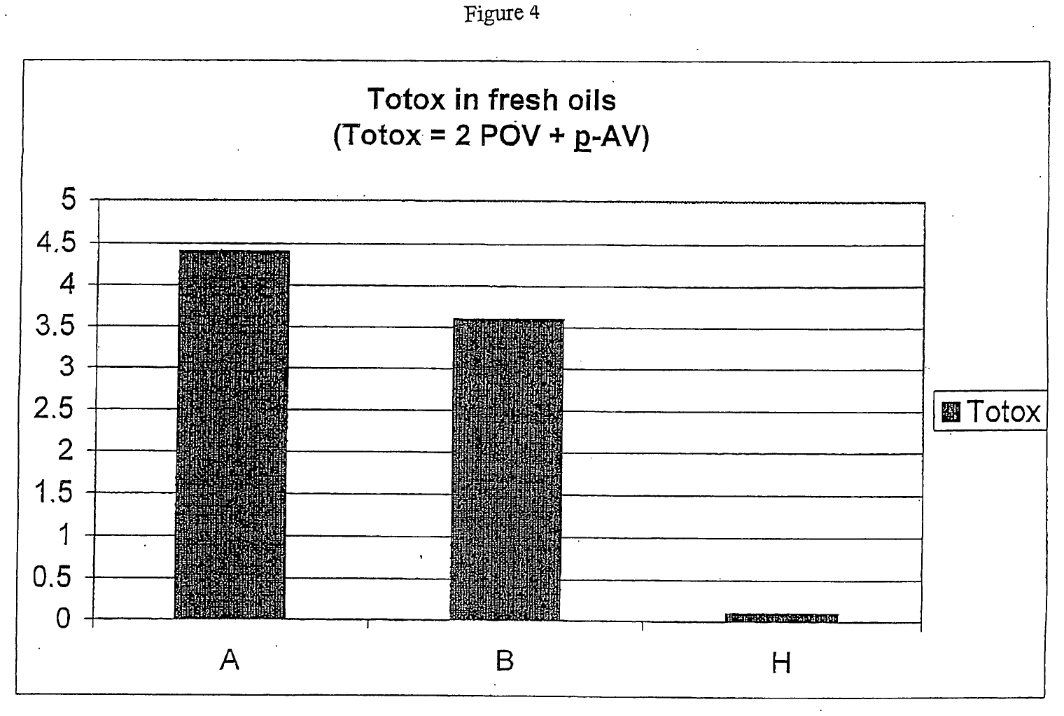

FIG. 4 is a block graph showing the Totox value of oils A, B and H.

It is apparent from Tables 1 and 2 above and FIGS. 1 to 4 that oil treated in accordance with the process of the invention (oil H) gave significantly better values in all analyses than untreated oil (oil A). Moreover, the POV, p-AV and Totox values for oil H were significantly lower than those for an oil where the citric acid was added to the fresh oil immediately after processing (oil B), even though identical amounts of other antioxidants were added to oil B and oil H after processing. In addition, the IP of oil H was surprisingly longer than the IPs of both oil A and oil B. The addition of citric acid to the fresh oil was not found to have any positive effect.

These results are particularly surprising as they suggest that citric acid protects against oxidation of the oil whilst being dissolved mainly in the water phase rather than the oil phase of the processing mixture. Consequently, oil H is expected to contain very low levels of citric acid due to the low solubility of citric acid in oil.

1. A process for stabilising an unsaturated oil which comprises treating the raw material with an organic acid prior to separating the oil from the raw material.

2. A process according to claim 1 in which the unsaturated oil is a vegetable, marine or single cell oil.

3. A process according to claim 1 or claim 2 in which the unsaturated oil is a marine oil.

4. A process according to any one of the preceding claims in which the unsaturated oil is a fish oil.

5. A process according to any one of the preceding claims in which the unsaturated oil is an omega-3 unsaturated oil.

6. A process according to any one of claims 1 to 4 in which the unsaturated oil is an omega-6 unsaturated oil.

7. A process according to any one of the preceding claims in which the organic acid is an optionally substituted short chain mono-, di- or tri-basic carboxylic acid, an alkylenediaminetetraacetic acid or a mixture thereof.

8. A process according to any one of the preceding claims in which the organic acid is an optionally substituted C₁₋₃ monobasic carboxylic acid, oxalic acid, citric acid or ethylenediaminetetraacetic acid.

9. A process according to any one of the preceding claims in which the organic acid is citric acid.

10. A process according to any one of the preceding claims in which an antioxidant is added to the processed oil.

11. A process according to claim 10 in which the antioxidant is selected from the group consisting of tocopherols, ascorbyl palmitate, lecithin, tocotrienols and mixtures thereof.

12. A process according to claim 11 in which the antioxidant comprises a mixture of a tocopherol, ascorbyl palmitate and lecithin.
